(19) United States
(12) Patent Application Publication
(10) Pub. No.: US 2026/0010655 A1
(43) Pub. Date: Jan. 8, 2026

(54) CONTROL DEVICE, CONTROL METHOD, AND STORAGE MEDIUM

(71) Applicant: HONDA MOTOR CO., LTD., Tokyo (JP)

(72) Inventors: Tatsuro FUJIWARA, Tokyo (JP); Masafumi SAGARA, Tokyo (JP); Takeshi SASAJIMA, Tokyo (JP); Jumpei NOGUCHI, Tokyo (JP); Masashi YOSHIFUKU, Guangzhou (CN)

(73) Assignee: HONDA MOTOR CO., LTD., Tokyo (JP)

(21) Appl. No.: 19/250,109

(22) Filed: Jun. 26, 2025

(30) Foreign Application Priority Data
Jun. 26, 2024 (CN) 202410840996.0

(51) Int. Cl. G06F 21/62; B60W 50/00; B60W 50/14

(52) U.S. Cl. CPC G06F 21/629; B60W 50/0098; B60W 50/14; B60W 2540/215; B60W 2756/10

(57) ABSTRACT

A control device for a moving object, includes: an acquisition unit configured to acquire authority information related to an execution authority of a predetermined function executable by the moving object; and a control unit configured to execute the predetermined function based on the authority information. In a case where the execution authority is enabled, the control unit issues a first notification notifying that the execution authority is enabled, stops the first notification in response to an abnormality occurring in acquiring the authority information in a state where a selection of the predetermined function is not made, and stops, in response to an abnormality occurring in acquiring the authority information in a state where a selection of the predetermined function is made, the first notification after cancelling the selection of the predetermined function.

This application is based upon and claims the benefit of priority from prior Chinese patent application No. 202410840996.0, filed on Jun. 26, 2024, the entire contents of which are incorporated herein by reference.

### TECHNICAL FIELD

The present disclosure relates to a control device, a control method, and a storage medium storing a control program.

### BACKGROUND ART

In recent years, efforts have been made to provide access to a sustainable transportation system in consideration of people vulnerable among traffic participants. In order to implement the above, focus has been placed on research and development on further improving safety and convenience of traffic by research and development related to a preventive safety technique.

In the related art, there is known a license management system in which a user acquires license data for enabling a function of a vehicle, management data associating the license data with the vehicle is managed outside the vehicle, and the vehicle acquires the management data from the outside, thus enabling the function in the vehicle. In the license management system, when a predetermined function is enabled in the vehicle, the user may be notified that the function is available, for example, by turning on an indicator. Further, when a predetermined function is being executed, an image related to the execution of the function may be displayed on a display screen of the vehicle to notify the user.

### SUMMARY OF INVENTION

When the vehicle cannot acquire the management data from the outside due to a malfunction and effectiveness of the function cannot be guaranteed in a state where both the notification based on turning on of the indicator and the notification based on the image display are issued, it is necessary to change notification contents that are based on the indicator and the image. However, depending on a change timing at which the notification content based on the indicator and the notification content based on the image display are changed, it may be difficult for the user to recognize the notification content.

JP2021-59278A discloses a display control device in which a device related to display control of a vehicle is connected via a communication bus such as a controller area network (CAN) bus, and in a case where CAN data cannot be acquired, an abnormality image indicating that there is an abnormality is displayed in a display area to remind an occupant of an abnormality of an in-vehicle device.

JP2023-68389A discloses a vehicle notification system in which behavior of a vehicle is detected based on information collected from various sensors or the like, whether it is necessary to take over driving to a driver is determined, and when it is determined that the takeover is necessary, display for taking over to the driver is displayed on a drawing display unit.

JP2021-62683A discloses a parking assistance device configured such that a parking assistance electronic control unit (ECU) and a drive ECU transmit and receive signals via a CAN, and when a communication abnormality occurs between the parking assistance ECU and the drive ECU, the vehicle can travel according to a driver-requested driving force by terminating a driving force limitation even if a condition for terminating the parking assistance control is not satisfied.

However, JP2021-59278A, JP2023-68389A, and JP2021-62683A do not clearly describe the timing of changing the notification that is based on the indicator and the timing of changing the notification that is based on the image display. Accordingly, in movement control of the vehicle, there is a room for improvement in ways of notifying a user in a plurality of manners such as the indicator and the image display.

Aspects of the present disclosure relate to providing a control device, a control method, and a storage medium storing a control program capable of preventing confusion of a user regarding execution of a function of a moving object.

According to an aspect of the present disclosure, there is provided a control device for a moving object, including:
an acquisition unit configured to acquire authority information related to an execution authority of a predetermined function executable by the moving object; and
a control unit configured to execute the predetermined function based on the authority information, in which
in a case where the execution authority is enabled, the control unit
   issues a first notification notifying that the execution authority is enabled,
   stops the first notification in response to an abnormality occurring in acquiring the authority information in a state where a selection of the predetermined function is not made, and
   stops, in response to an abnormality occurring in acquiring the authority information in a state where a selection of the predetermined function is made, the first notification after cancelling the selection of the predetermined function.

According to an aspect of the present disclosure, there is provided a control method to be performed by a control device for a moving object, the control device including an acquisition unit configured to acquire authority information related to an execution authority of a predetermined function executable by the moving object, and a processor configured to execute the predetermined function based on the authority information, the control method including:
in a case where the execution authority is enabled,
   issuing, by the processor, a first notification notifying that the execution authority is enabled;
   stopping, by the processor, the first notification in response to an abnormality occurring in acquiring the authority information in a state where a selection of the predetermined function is not made; and
   stopping, by the processor, in response to an abnormality occurring in acquiring the authority information in a state where a selection of the predetermined function is made, the first notification after cancelling the selection of the predetermined function.

According to an aspect of the present disclosure, there is provided a non-transitory computer-readable storage medium storing a control program of a control device for a moving object, the control device including an acquisition unit configured to acquire authority information related to an execution authority of a predetermined function executable by the moving object, and a processor configured to execute the predetermined function based on the authority information, the control program causing the processor to:
in a case where the execution authority is enabled,
   issue a first notification notifying that the execution authority is enabled;
   stop the first notification in response to an abnormality occurring in acquiring the authority information in a state where a selection of the predetermined function is not made; and
   stop, in response to an abnormality occurring in acquiring the authority information in a state where a selection of the predetermined function is made, the first notification after cancelling the selection of the predetermined function.

According to aspects of the present disclosure, a control device, a control method, and a storage medium storing a control program capable of preventing confusion of a user regarding execution of a function of a moving object can be provided. This contributes to development of a sustainable transportation system.

### BRIEF DESCRIPTION OF DRAWINGS

Exemplary embodiment(s) of the present invention will be described in detail based on the following figures, wherein:

FIG. 1 is a diagram showing an example of a configuration of a FoD system 1 including a control device of the present embodiment;

FIG. 2 is a block diagram illustrating functions of the control device of the present embodiment;

FIG. 3 is a diagram showing an example of the control device mounted on a vehicle;

FIG. 4 is a flowchart showing an example of control on a display screen during execution of automated parking of the vehicle;

FIG. 5 is a flowchart showing an example of control on an SW/indicator that notifies the presence or absence of an execution authority related to the automated parking;

FIG. 6 is a diagram showing an example of images on a normal screen displayed on a display of an input/output device;

FIG. 7 is a diagram showing an example of images displayed when an automated parking SW/indicator for starting the automated parking of the vehicle is pressed;

FIG. 8 is a diagram showing an example of an image displayed when a remote parking button for starting the automated parking of the vehicle is pressed;

FIG. 9 is a diagram showing an example of an image displayed when a parking frame for automatically parking the vehicle is selected;

FIG. 10 is a diagram showing an example of an image displayed when a parking position of the vehicle is selected in remote parking;

FIG. 11 is a diagram showing an example of an image displayed at a stage where the parking frame is not selected on a parking position selection screen;

FIG. 12 is a diagram showing an example of an image displayed at a stage where the parking frame is not selected on a parking position selection screen in the remote parking;

FIG. 13 is a diagram showing an example of an image displayed during execution of the automated parking using an APS; and

FIG. 14 is a diagram showing an example of an image displayed during execution of the automated parking using an RPS.

### DESCRIPTION OF EMBODIMENTS

Hereinafter, an embodiment of a control device of the present disclosure will be described with reference to the drawings. In the following description of the embodiment, an example in which a moving object in the present disclosure is a vehicle 30 such as an automobile will be described.

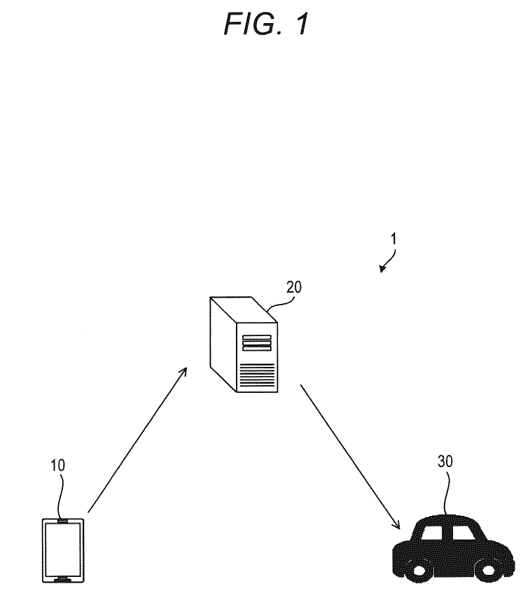

FIG. 1 is a diagram showing an example of a configuration of a function on demand (FoD) system 1 including a control device of the present embodiment. As shown in FIG. 1, the FoD system 1 includes a server 20, and a vehicle 30 and an information terminal 10 which can communicate with the server 20. Although one vehicle 30 is shown in this example, the number of vehicles may be plural.

The server 20 is an external server installed in a facility such as a management center. The server 20 manages authority information related to an execution authority of the vehicle, that is acquired when a certain user uses the vehicle 30, in association with the user (user ID).

The server 20 controls to enable/disable (ON/OFF) a function of the vehicle 30 when the user uses the vehicle 30. Specifically, the server 20 performs control for switching enabling/disabling of a function in the vehicle 30 by transmitting, to the vehicle 30, a function ON signal for enabling the function or a function OFF signal for disabling the function.

The information terminal 10 is an information terminal owned by the user, such as a smartphone. After purchasing the vehicle 30, for example, the user uses the information terminal 10 to online purchase an execution authority related to a predetermined function of the vehicle 30. The user can use the purchased function in the vehicle 30 by transmitting an execution authority ID acquired by the purchase from the information terminal 10 to the server 20.

The vehicle 30 is a vehicle capable of performing so-called automated driving or assistance driving. The vehicle 30 may be a vehicle whose user is limited, such as a vehicle owned by an individual, or a vehicle whose user is not limited, such as a vehicle owned by a corporation. Those who can use a vehicle owned by an individual include, for example, the owner of the vehicle, his or her family, relatives, friends, and the like. The vehicle owned by a corporation includes a vehicle available to an unspecified number of users under a predetermined contract, such as a rental car or a shared car. The control device of the present embodiment is a control device provided in the vehicle 30, and can control automated driving or assistance driving of the vehicle 30.

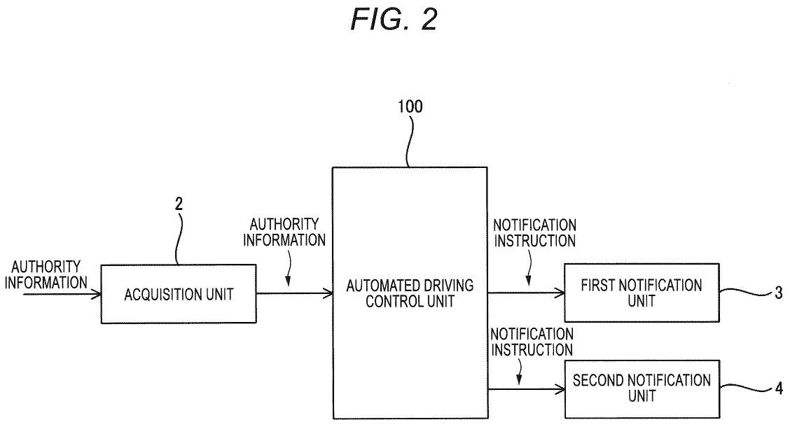

FIG. 2 is a block diagram illustrating functions of the control device of the present embodiment. As shown in FIG. 2, a control device 300 includes an acquisition unit 2 that acquires the authority information of the vehicle 30 from the outside, and an automated driving control unit 100 that performs control related to automated parking of the vehicle 30 based on the authority information acquired by the acquisition unit 2. Further, the control device 300 includes a first notification unit 3 and a second notification unit 4 that operate based on a notification instruction from the automated driving control unit 100. Each unit is connected by, for example, a controller area network (CAN) communication network.

The acquisition unit 2 acquires authority information related to an execution authority of a predetermined function executable by the vehicle 30 from, for example, the server 20. The predetermined function is a function related to movement control of the vehicle 30. The predetermined function includes, for example, automated parking (APS: auto parking system, RPS: remote parking system, and the like) of the vehicle 30. Further, the predetermined function may include automated exit of the vehicle 30, auto lane changing (ALC), parking assistance for displaying an image for assisting parking, and the like.

The automated driving control unit 100 executes a predetermined function executable in the vehicle 30 based on the authority information acquired by the acquisition unit 2. For example, in a case where the execution authority of the predetermined function based on the authority information is enabled, the automated driving control unit 100 issues a first notification notifying that the execution authority is enabled. The execution authority of the predetermined function being enabled means that the function can be executed in the vehicle 30. For example, in a case where the predetermined function is a function related to the automated parking of the vehicle 30, the first notification is turning on an indicator for notifying that the automated parking is executable.

In a case where an abnormality occurs in the acquisition of the authority information in a state where the predetermined function is not selected, the automated driving control unit 100 stops the first notification. The state where the predetermined function is not selected is a state where the user does not select the function of the vehicle 30. For example, in a case where the predetermined function is the function related to the automated parking of the vehicle 30, the state where the predetermined function is not selected is a state where an automated parking button for starting the automated parking is not pressed. The occurrence of an abnormality in the acquisition of the authority information means occurrence of a state where the authority information cannot be normally acquired due to, for example, an abnormality in the communication unit (the acquisition unit 2), an abnormality in a communication section between the server 20 and the communication unit (for example, a communication abnormality due to a large shield or radio wave interference), or an abnormality in the server 20.

In addition, in a case where an abnormality occurs in the acquisition of the authority information in a state where a predetermined function is selected, the automated driving control unit 100 stops the first notification after cancelling the selection of the predetermined function. The state where the predetermined function is selected is a state where the predetermined function is selected by a selection operation by the user from among the functions of the vehicle 30. For example, in a case where the predetermined function is the function related to the automated parking of the vehicle 30, the state where the predetermined function is selected is a state where the automated parking button is pressed. In other words, the state is a state where the predetermined function is being prepared for execution or being executed, that is, a state where the user intends to execute the predetermined function. The cancellation of the selection of the predetermined function means returning a state which is transitioned to by selecting the function. For example, in a case where the predetermined function is the function related to the automated parking of the vehicle 30, when an automated parking execution screen is displayed based on pressing of the automated parking button, the screen is returned to a normal screen displayed when the automated parking button is not pressed. The normal screen includes, for example, external world information around the vehicle 30.

In addition, the automated driving control unit 100 issues a second notification related to the execution of the predetermined function in a state where the predetermined function is selected. For example, in a case where the predetermined function is the function related to the automated parking of the vehicle 30, the second notification is to display an automated parking execution screen for notifying a status of the automated parking. The automated driving control unit 100 continuously issues the first notification during a period in which the second notification is being issued. That is, the automated driving control unit 100 does not stop the first notification while the second notification is being issued, and stops the first notification after stopping the second notification.

The first notification unit 3 issues the first notification based on the notification instruction of the automated driving control unit 100. For example, in a case where the predetermined function is the function related to the automated parking of the vehicle 30, the first notification unit 3 turns on the indicator for notifying that the automated parking is executable. The second notification unit 4 issues the second notification based on the notification instruction of the automated driving control unit 100. For example, in a case where the predetermined function is the function related to the automated parking of the vehicle 30, the second notification unit 4 displays the automated parking execution screen for notifying the status of the automated parking.

Further, in a state where the execution authority of the predetermined function is enabled and the predetermined function is selected, when an abnormality occurs in the acquisition of the authority information before the execution of the selected predetermined function, the automated driving control unit 100 stops the first notification after issuing a third notification notifying that the predetermined function cannot be executed. The third notification is, for example, a notification indicating that the automated parking cannot be executed in a case where the selected predetermined function is the function related to the automated parking of the vehicle 30. Further, in a state where the execution authority of the predetermined function is enabled and the predetermined function is selected, when an abnormality occurs in the acquisition of the authority information during the execution of the selected predetermined function, the automated driving control unit 100 stops the first notification after issuing a fourth notification notifying that the execution of the predetermined function is to be stopped and stopping the execution of the predetermined function. The fourth notification is, for example, a notification indicating that the execution of the automated parking is to be stopped in a case where the selected predetermined function is the function related to the automated parking of the vehicle 30.

When an abnormality occurs in the acquisition of the authority information in a state where the predetermined function is selected and the second notification related to the execution of the predetermined function is being issued, the automated driving control unit 100 stops the first notification after the display screen of the second notification related to the execution of the predetermined function is transitioned to the normal screen displayed when the predetermined function is not selected. The second notification is an example of a “first screen display” of the present disclosure. The normal screen is an example of a “second screen display” of the present disclosure.

Further, the automated driving control unit 100 determines whether an abnormality occurs in the acquisition of the authority information based on, for example, an abnormality in CAN communication between the acquisition unit 2 and the automated driving control unit 100.

The automated driving control unit 100 determines whether an abnormality occurs in the communication between the acquisition unit 2 and the automated driving control unit 100 based on a period in which there is no response from the acquisition unit 2. For example, when a period in which there is no response from the acquisition unit 2 continues for 2000 ms, the automated driving control unit 100 determines that a time-out error occurs.

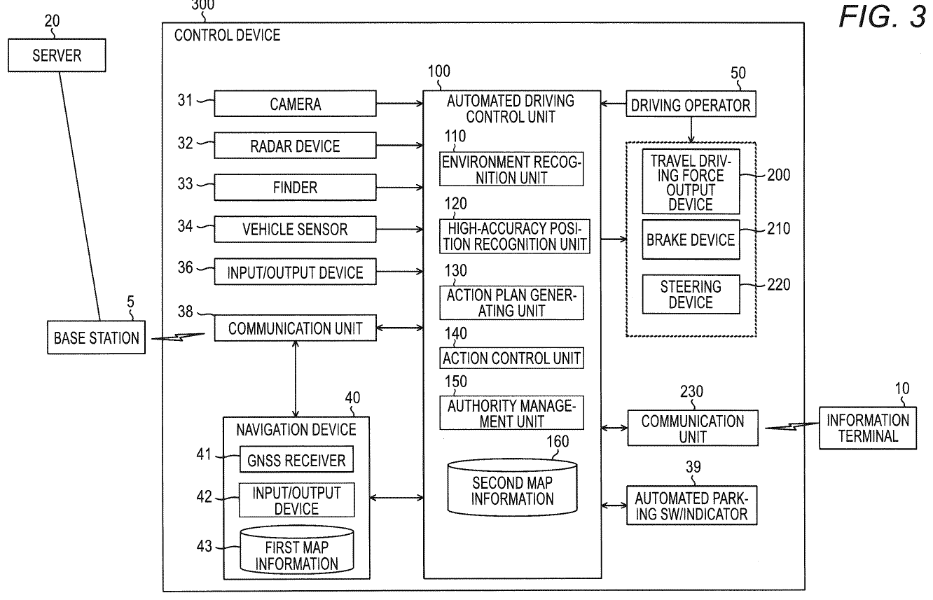

FIG. 3 is a diagram showing an example of the control device 300 mounted on the vehicle 30. As shown in FIG. 3, the control device 300 includes a camera 31, a radar device 32, a finder 33, a vehicle sensor 34, an input/output device 36, a communication unit 38, an automated parking SW/indicator 39, and a navigation device 40. Further, the control device 300 includes a driving operator 50, the automated driving control unit 100, a travel driving force output device 200, a brake device 210, a steering device 220, and a communication unit 230. These devices are communicably connected to each other via a wired or wireless communication network. The communication network connecting these devices is, for example, a CAN.

The camera 31 is a digital camera that images surroundings of the vehicle 30 (for example, the front of the vehicle 30), and outputs external world information (image data) obtained by the imaging to the automated driving control unit 100. The radar device 32 is, for example, a radar device using radio waves in a millimeter waveband, detects a position of an object around the vehicle 30 (for example, in front of, behind, and on a lateral side of the vehicle 30), and outputs the detection result to the automated driving control unit 100.

The finder 33 is, for example, a laser imaging detection and ranging (LIDAR), measures a distance to a position (target object) of an object around the vehicle 30 (for example, in front of, behind, and on the lateral side of the vehicle 30) using predetermined laser light, and outputs the measurement result to the automated driving control unit 100. The camera 31, the radar device 32, and the finder 33 are an example of an “external world information acquisition unit” of the present disclosure.

The vehicle sensor 34 includes, for example, a vehicle speed sensor that detects a speed of the vehicle 30, an acceleration sensor that detects an acceleration of the vehicle 30, an angular speed sensor that detects an angular speed of the vehicle 30 around a vertical axis, and an azimuth sensor that detects a direction of the vehicle 30. The vehicle sensor 34 includes a radio wave intensity sensor that detects an intensity (that is, communication environment) of radio waves used by the communication unit 38 for communication. Further, the vehicle sensor 34 includes a face recognition device for recognizing a face of a driver, a fingerprint sensor for detecting a fingerprint of the driver, and a voiceprint sensor for detecting a voiceprint of the driver. The vehicle sensor 34 outputs the detection result of each sensor to the automated driving control unit 100.

The input/output device 36 includes an output device that outputs various types of information to a user of the vehicle 30 (hereinafter, also simply referred to as a user), and an input device that receives various types of input operations from the user. The output device of the input/output device 36 is, for example, a display that performs display based on a processing result of the automated driving control unit 100. The output device may be a speaker, a buzzer, an indicator lamp, or the like.

Further, the input device of the input/output device 36 is, for example, a touch panel or an operation button (such as a key, or a switch) that outputs an operation signal corresponding to an input operation received from the user to the automated driving control unit 100. For example, identification information for identifying the user, function information of the vehicle 30 desired to be acquired by the user, and the like are input to the input device of the input/output device 36. The identification information received from the input device includes, for example, a name, an address, a credit number, and a telephone number of the user. The function information of the vehicle 30 received from the input device includes function information related to automated driving and assistance driving. Further, the function information may include, for example, function information related to safety of the vehicle 30, and function information related to comfort.

The communication unit 38 is a communication interface that is wirelessly connected to the base station 5 and performs vehicle communication with the server 20 via the base station 5. The communication unit 38 transmits the authority information of the vehicle 30 acquired by the user and the identification information capable of identifying the user to the server 20 via the base station 5. Further, the communication unit 38 receives authority information related to execution authority of a predetermined function executable by the vehicle 30 from the server 20 via the base station 5. The authority information includes contract information of the user of the vehicle 30.

The communication unit 38 is an example of the “acquisition unit 2” of the present disclosure. The communication unit 38 may be implemented by, for example, a telematics control unit (TCU) capable of bidirectional communication. The communication unit 38 may use, for example, a cellular network, a Wi-Fi (registered trademark) network, Bluetooth (registered trademark), Dedicated Short Range Communication (DSRC), or the like. Further, the communication unit 38 may receive the authority information or the like of the vehicle 30 from the information terminal 10 owned by the user, for example, by bluetooth low energy (BLE: registered trademark).

The automated parking SW/indicator 39 is a button for starting or ending the automated parking of the vehicle 30, and a display device for notifying whether the automated parking of the vehicle 30 can be executed (execution authority). The automated parking can be executed when the automated parking SW/indicator 39 is turned on, for example, and the automated parking cannot be executed when the automated parking SW/indicator 39 is turned off. The automated parking can be started or ended by pressing the automated parking SW/indicator 39 when the automated parking SW/indicator 39 is turned on. That is, the execution authority of the automated parking is enabled when the automated parking SW/indicator 39 is turned on.

The navigation device 40 includes a global navigation satellite system (GNSS) receiver 41 and an input/output device 42. Further, the navigation device 40 includes a storage device (not shown) such as a hard disk drive (hereinafter, referred to as an HDD) or a flash memory, and the storage device stores first map information 43. The first map information 43 is, for example, information indicating a road shape by links indicating roads and nodes connected by the links. In addition, the first map information 43 may include information indicating a curvature of the road or a point of interest (POI).

The GNSS receiver 41 specifies latitude and longitude of a location where the vehicle 30 is located as the position of the vehicle 30 based on a signal received from a GNSS satellite. Further, the navigation device 40 may specify or correct the position of the vehicle 30 by an inertial navigation system (INS) using the output of the vehicle sensor 34.

The input/output device 42 includes an output device that outputs various types of information to the user and an input device that receives various types of input operations from the user. The output device of the input/output device 42 is, for example, a display that performs display based on a processing result of the navigation device 40 (for example, displays an on-map route to be described later). Further, the input device of the input/output device 42 is, for example, a touch panel or an operation button (such as a key or a switch) that outputs an operation signal corresponding to an input operation received from the user to the navigation device 40. The input/output device 42 may be shared with the input/output device 36.

Although detailed description is omitted, for example, the navigation device 40 determines a route (hereinafter, also referred to as an on-map route) from the position of the vehicle 30 specified by the GNSS receiver 41 to a destination input by the user with reference to the first map information 43. The navigation device 40 guides the user through the determined on-map route using the input/output device 42. The navigation device 40 is configured to output information indicating the specified position of the vehicle 30 and the determined on-map route to the automated driving control unit 100.

The driving operator 50 are various operators such as an accelerator pedal, a brake pedal, a shift lever, a steering wheel, a modified steering wheel, and a joystick. The driving operator 50 is provided with a sensor that detects an operation amount or the presence or absence of an operation for the driving operator 50. A detection result of the sensor for the driving operator 50 is output to a part or all of the automated driving control unit 100, the travel driving force output device 200, the brake device 210, and the steering device 220.

The travel driving force output device 200 outputs, to driving wheels, a travel driving force (torque) for traveling of the vehicle 30. The travel driving force output device 200 includes, for example, an electric motor and an electric motor electronic control unit (ECU) that controls the electric motor. The electric motor ECU controls the electric motor based on a detection result of a sensor of the driving operator 50 (for example, the accelerator pedal) or control information from the automated driving control unit 100. When the vehicle 30 includes an internal combustion engine or a transmission as a drive source, the travel driving force output device 200 may include the internal combustion engine or the transmission and an ECU that controls the internal combustion engine or the transmission.

The brake device 210 includes, for example, a brake caliper, a cylinder that transmits hydraulic pressure to the brake caliper, an electric motor that generates the hydraulic pressure in the cylinder, and a brake ECU. The brake ECU controls the electric motor of the brake device 210 based on a detection result of a sensor of the driving operator 50 (for example, the brake pedal) and control information from the automated driving control unit 100 such that a brake torque corresponding to a brake operation is output to each wheel.

The steering device 220 includes, for example, a steering ECU and an electric motor.

The electric motor of the steering device 220 changes an orientation of a steered wheel, for example, by applying a force to a rack-and-pinion mechanism. The steering ECU drives the electric motor of the steering device 220 based on a detection result of a sensor of the driving operator 50 (for example, the steering wheel) and control information from the automated driving control unit 100 to change a direction of the steered wheel (that is, a steering angle).

The communication unit 230 is a communication interface that performs direct communication with the information terminal 10. The information terminal 10 transmits a remote instruction signal for automated parking or automated exit of the vehicle 30 from the outside to the vehicle 30 by wireless communication. An application capable of automatically controlling the vehicle 30 by transmitting and receiving information related to a remote instruction on the vehicle 30 to and from the vehicle 30 is installed in the information terminal 10. The vehicle 30 receives the remote instruction signal transmitted from the information terminal 10 through the communication unit 230. The automated driving control unit 100 of the vehicle 30 controls the automated parking or the automated exit of the vehicle 30 according to the remote instruction signal received through the communication unit 230. For example, BLE is used as the wireless communication.

The automated driving control unit 100 includes an environment recognition unit 110, a high-accuracy position recognition unit 120, an action plan generating unit 130, an action control unit 140, and an authority management unit 150. Further, the automated driving control unit 100 includes a storage device (not shown) implemented by a flash memory or the like accessible by each functional unit (for example, the high-accuracy position recognition unit 120) of the automated driving control unit 100, and second map information 160 is stored in the storage device.

The environment recognition unit 110 performs sensor fusion processing on information acquired by a part or all of the camera 31, the radar device 32, and the finder 33, and recognizes an object around the vehicle 30 and a position thereof. The environment recognition unit 110 recognizes, for example, an obstacle, a road shape, a traffic light, a guard rail, a utility pole, a surrounding vehicle (including a traveling state such as a speed or an acceleration and a parking state), a lane mark, a pedestrian, and the like, and recognizes positions thereof.

The environment recognition unit 110 is an example of the “external world information acquisition unit” of the present disclosure.

The high-accuracy position recognition unit 120 recognizes a detailed position and a posture of the vehicle 30 with reference to the position of the vehicle 30 specified by the navigation device 40, the detection result of the vehicle sensor 34, the image captured by the camera 31, the second map information 160, and the like. The high-accuracy position recognition unit 120 recognizes, for example, a travel lane in which the vehicle 30 is traveling, and recognizes a relative position and a posture of the host vehicle with respect to the travel lane.

The action plan generating unit 130 generates an action plan of the vehicle 30. Specifically, the action plan generating unit 130 generates a target trajectory along which the vehicle 30 travels in the future as the action plan of the vehicle 30. The target trajectory is, for example, information expressed by arranging locations (trajectory points) at which the vehicle 30 is to arrive every predetermined travel distance (for example, about several meters). The target trajectory may include information of a speed element such as a target speed or a target acceleration of the vehicle 30 for each predetermined time point or each trajectory point.

The action control unit 140 controls the vehicle 30 to act according to the action plan generated by the action plan generating unit 130. Specifically, the action control unit 140 controls the travel driving force output device 200, the brake device 210, and the steering device 220 such that the vehicle 30 passes through the target trajectory generated by the action plan generating unit 130 at a scheduled time point. The action control unit 140 controls the travel driving force output device 200 and the brake device 210 based on, for example, the speed element associated with the target trajectory, and controls the steering device 220 according to a degree of curvature of the target trajectory.

The authority management unit 150 manages the authority information related to the execution authority of a predetermined function executable by the vehicle 30 and received by the automated driving control unit 100 from the server 20 via the communication unit 38.

The second map information 160 is map information with higher accuracy than the first map information 43. The second map information 160 includes, for example, information indicating a center of a lane, information indicating a boundary line (for example, a road division line) of the lane, and the like. Further, the second map information 160 may include road information, traffic regulation information, address information, facility information, telephone number information, and the like. The second map information 160 may be updated as needed. The second map information 160 may be updated, for example, based on information acquired by a part or all of the camera 31, the radar device 32, and the finder 33.

Each functional unit of the automated driving control unit 100 is implemented by, for example, a CPU executing a predetermined program (software). Further, a part or all of the functional units of the automated driving control unit 100 may be implemented by hardware such as a large scale integration (LSI), an application specific integrated circuit (ASIC), an FPGA, and a graphics processing unit (GPU). For example, the storage device that stores the second map information 160 and the high-accuracy position recognition unit 120 each may be implemented by a map positioning unit (MPU). Further, a part or all of the functional units of the automated driving control unit 100 may be implemented by cooperation of software and hardware.

The vehicle 30 on which the control device 300 having such a configuration is mounted is a vehicle capable of automated driving under automated driving control. A level of the automated driving is classified into level 0 to level 5 depending on a degree of automation, for example, based on SEAJ3016 determined by SAE International. A high degree of automation means, for example, that a degree of controlling the vehicle based on an operation of the driver (user) with respect to the vehicle 30 is low, that is, the number of tasks such as monitoring the surroundings of the vehicle 30 required for the driver is small.

Specifically, level 0 is a driving level without automation. At level 0, the driver performs all driving operations. Level 1 is a driving level (driving assistance) at which the vehicle 30 performs any operation of acceleration, steering, and braking. At Level 1, under a specific condition, the vehicle 30 controls an operation on any one of the accelerator, the brake, and the steering wheel according to a surrounding situation, and the driver of the vehicle 30 performs all other driving operations. Level 2 is a driving level (partial driving automation) at which the vehicle 30 performs a plurality of operations among acceleration, steering, and braking at once. At level 2, the driver of the vehicle 30 needs to monitor the surroundings. Level 3 is a driving level (conditional automated driving) at which the control device 300 performs all of acceleration, steering, and braking, and the driver responds only when requested by the control device 300. At Level 3, the control device 300 monitors the surroundings, and the driver of the vehicle 30 does not need to monitor the surroundings. Level 4 is a driving level (highly automated driving) at which the vehicle 30 performs all driving operations in a specific situation, and the driver of the vehicle 30 does not need to be replaced even if the control device 300 is unable to continue the driving. Level 5 is a driving level (fully automated driving) at which the control device 300 performs automated driving under all conditions. Therefore, at level 4 and level 5, the control device 300 responds even in an emergency.

The conditions under which the driving at Level 0 to Level 5 is performed are examples, and may be freely set as long as the degree of automation of the vehicle 30 decreases, that is, the number of tasks of the driver increases in the order of Level 5, Level 4, Level 3, Level 2, Level 1, and Level 0. For example, a part or all of the levels 1 to 5 may be in an automated driving state, or a part or all of the levels 1 to 5 may not be in the automated driving state but may be in a state where the driving assistance is executed. The number of driving levels to be classified is not limited to six.

The functions of the vehicle 30 are functions related to the automated driving and the assistance driving of the vehicle 30. The functions of the vehicle 30 may include all functions related to the automated driving and the assistance driving of the vehicle 30. For example, the driving levels 1 to 5 of the vehicle 30 may correspond to functions A to E of the vehicle 30, respectively. For example, an adaptive cruise control system, a lane keeping assist system, a constant speed traveling function, an auto lane changing function, a take over function, a branching function, a merging function, and the like may be provided as the functions of the vehicle 30.

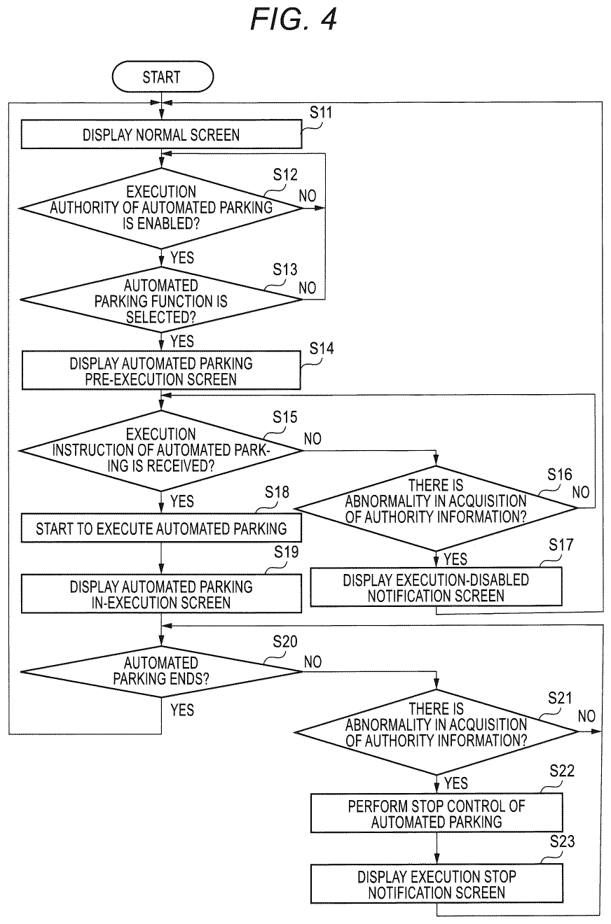

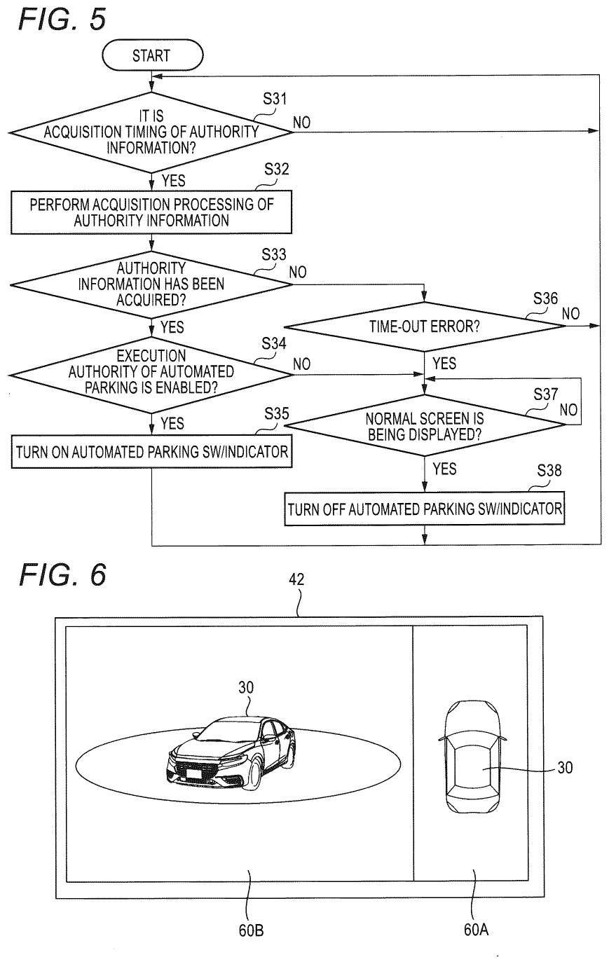

Next, a control example of the control device 300 during the automated parking of the vehicle 30 will be described with reference to FIGS. 4 and 5. FIG. 4 is a flowchart showing an example of control on a display screen during the automated parking of the vehicle 30.

First, it is assumed that the control device 300 displays a normal screen, which is displayed when the automated parking is not selected, on the display of the input/output device 42 in the navigation device 40 of the vehicle 30, for example (step S11). The normal screen is, for example, a top view image and a three-dimensional image of the vehicle 30 (see, for example, FIG. 6).

Next, the control device 300 determines whether the execution authority of the automated parking in the vehicle 30 is enabled (step S12). The execution authority of the automated parking being enabled means that the authority information indicating that the execution authority of the automated parking is enabled has been successfully acquired. The authority information having been successfully acquired means that the authority information has been recently acquired, for example, the authority information has been acquired without occurrence of a “time-out error” to be described later with reference to FIG. 5.

In step S12, when the execution authority of the automated parking is not enabled (step S12: No), the control device 300 repeats the processing of step S12. In step S12, when the execution authority of the automated parking is enabled (step S12: Yes), the control device 300 determines whether the automated parking function of the vehicle 30 is selected (step S13). The automated parking function being selected means, for example, that the automated parking SW/indicator 39 of the vehicle 30 is pressed by the user.

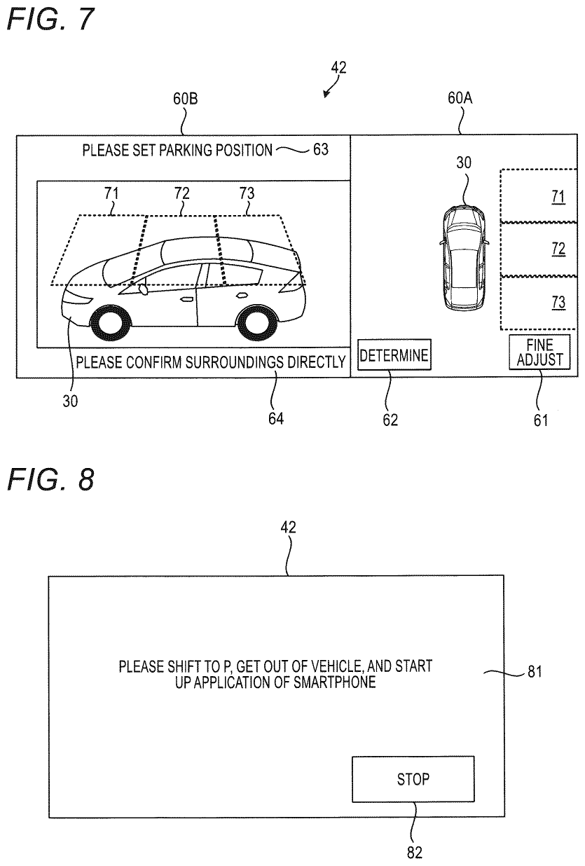

In step S13, when the automated parking function is not selected (step S13: No), the control device 300 returns to step S12 and repeats each processing. In step S13, when the automated parking function is selected (step S13: Yes), the control device 300 displays an automated parking pre-execution screen on the display of the input/output device 42 (step S14). The automated parking pre-execution screen is, for example, a screen on which the top view image and the three-dimensional image of the vehicle 30 and a parking frame (target position) for parking the vehicle 30 are displayed (for example, see FIG. 7 or 8). The automated parking pre-execution screen is an example of a “second notification” of the present disclosure.

Next, the control device 300 determines whether an execution instruction of the automated parking is received (step S15). The execution instruction of the automated parking being received means, for example, that the parking frame is selected by the user on the screen of the top view image and the three-dimensional image of the vehicle 30 and the parking frame (target position) for parking the vehicle 30 which is displayed in step S14.

In step S15, when the execution instruction of the automated parking is not received (step S15: No), the control device 300 determines whether there is an abnormality in the acquisition of the authority information (step S16). When there is an abnormality in the acquisition of the authority information, the authority information indicating that the execution authority of the automated parking of the vehicle 30 is enabled is not normally acquired. Specifically, a “time-out error” or the like, which will be described later with reference to FIG. 5, occurs.

In step S16, when there is no abnormality in the acquisition of the authority information (step S16: No), the control device 300 returns to step S15 and repeats each processing. In step S16, when there is an abnormality in the acquisition of the authority information (step S16: Yes), the control device 300 displays an execution-disabled notification screen on the display of the input/output device 42 (step S17). After displaying the execution-disabled notification screen, the control device 300 returns to step S11, displays the normal screen, and repeats the subsequent processing.

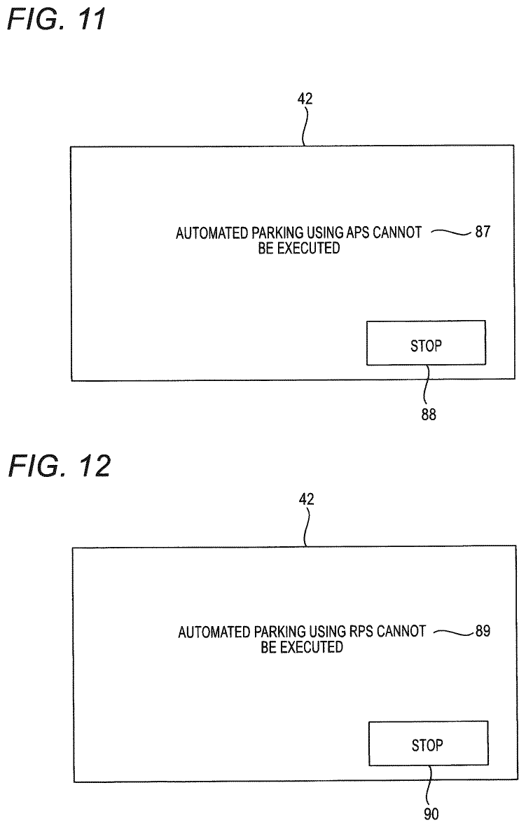

The execution-disabled notification screen is a screen for notifying the user that the automated parking of the vehicle 30 cannot be executed (for example, see FIG. 11 or 12). For example, the execution-disabled notification screen may be displayed on the display of the input/output device 42 together with the automated parking pre-execution screen displayed in step S14, or may be displayed on the display of the input/output device 42 instead of the automated parking pre-execution screen. Returning to step S11 and displaying the normal screen means returning the execution-disabled notification screen which is transitioned to due to the selection of the automated parking function to the normal screen (cancelling the selection of the function). The execution-disabled notification screen is an example of a “third notification” of the present disclosure.

On the other hand, in step S15, when the execution instruction of the automated parking is received, that is, when the parking frame is selected by the user (step S15: Yes), the control device 300 starts to execute the automated parking of the vehicle 30 into the selected parking frame (step S18).

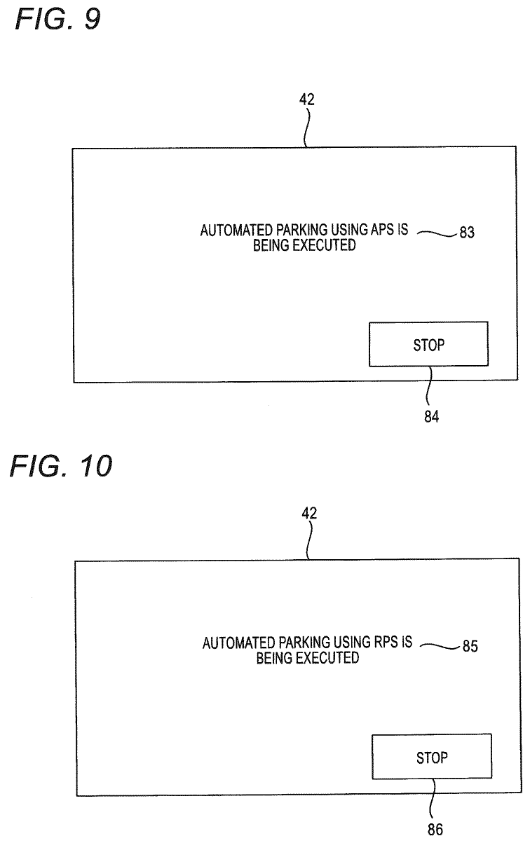

Next, the control device 300 displays an automated parking in-execution screen on the display of the input/output device 42 (step S19). The automated parking in-execution screen is a screen for notifying the user that the vehicle 30 is moving toward the parking frame selected by the user (for example, see FIG. 9 or 10). The automated parking in-execution screen may be displayed on the display of the input/output device 42 together with the screen indicating that the vehicle 30 is moving toward the parking frame in the automated parking pre-execution screen displayed in step S14, or only the automated parking in-execution screen may be displayed. The automated parking in-execution screen is an example of the “second notification” of the present disclosure.

Next, the control device 300 determines whether the automated parking of the vehicle 30 ends (step S20).

In step S20, when the automated parking ends (step S20: Yes), the control device 300 returns to step S11 and repeats each processing. In step S20, when the automated parking does not end (step S20: No), the control device 300 determines whether there is an abnormality in the acquisition of the authority information (step S21). A case where there is an abnormality in the acquisition of the authority information is similar to the case described in step S16.

In step S21, when there is no abnormality in the acquisition of the authority information (step S21: No), the control device 300 returns to step S20 and repeats each processing. In step S21, when there is an abnormality in the acquisition of the authority information (step S21: Yes), the control device 300 performs stop control to stop the automated parking of the vehicle 30 (step S22). The stopping the automated parking is to stop executing the automated parking of the vehicle 30, and for example, when the vehicle 30 is traveling, the traveling vehicle 30 is stopped and then the automated parking is stopped.

Next, the control device 300 displays an execution stop notification screen on the display of the input/output device 42 (step S23). After displaying the execution stop notification screen, the control device 300 returns to step S20 to determine whether the automated parking ends (here, whether the vehicle is stopped), and repeats the subsequent processing.

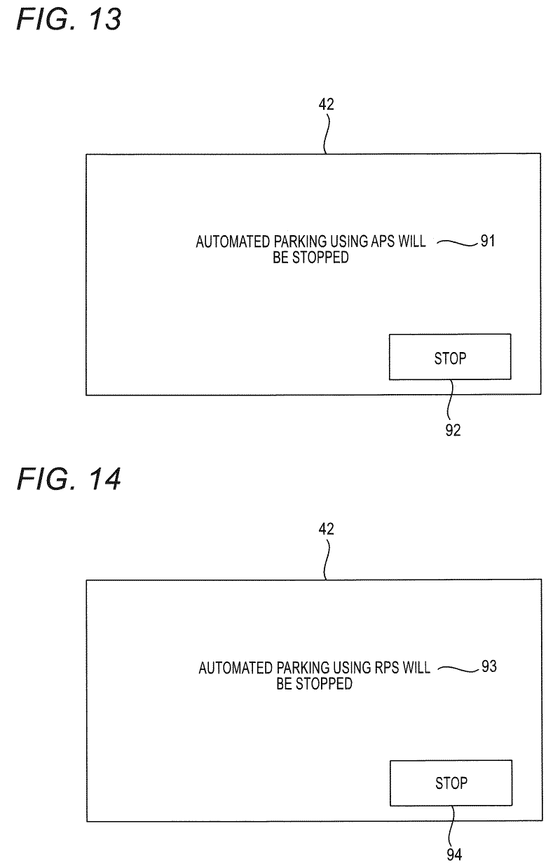

The execution stop notification screen is a screen for notifying the user that the execution of the automated parking of the vehicle 30 is stopped (for example, see FIG. 13 or 14). For example, the execution stop notification screen may be displayed on the display of the input/output device 42 together with the automated parking in-execution screen displayed in step S19, or may be displayed on the display of the input/output device 42 instead of the automated parking in-execution screen. The execution stop notification screen is an example of a “fourth notification” of the present disclosure.

FIG. 5 is a flowchart showing an example of control on the SW/indicator that notifies the presence or absence of the execution authority related to the automated parking. The control device 300 performs the control processing in parallel with the display screen control processing described in FIG. 4.

The control device 300 determines whether it is an acquisition timing to acquire the authority information (step S31). The acquisition timing of the authority information is set, for example, at a constant cycle. The control device 300 repeatedly acquires the authority information from the server 20 via the communication unit 38 every constant cycle.

In step S31, when it is not the acquisition timing (step S31: No), the control device 300 repeats the processing of step S31 until the acquisition timing is reached. In step S31, when it is the acquisition timing (step S31: Yes), the control device 300 performs acquisition processing of transmitting, to the server 20 via the communication unit, a request signal for requesting transmission of the authority information (step S32).

Next, the control device 300 determines whether the authority information transmitted from the server 20 has been acquired by the automated driving control unit 100 from the communication unit 38 through CAN communication (step S33).

In step S33, when the authority information has been acquired (step S33: Yes), the control device 300 determines whether the execution authority of the automated parking is enabled in the acquired authority information (step S34).

In step S34, when the execution authority of the automated parking is enabled (step S34: Yes), the control device 300 turns on the automated parking SW/indicator 39 for notifying that the authority is enabled (step S35). The turning on of the automated parking SW/indicator 39 is an example of a “first notification” of the present disclosure. After turning on the automated parking SW/indicator 39, the control device 300 returns to step S31 and repeats each processing.

On the other hand, in step S33, when the authority information has not been acquired (step S33: No), the control device 300 determines whether a time-out error occurs (step S36). The time-out error is an error that occurs when the authority information is not transmitted from the communication unit 38 to the automated driving control unit 100 for a predetermined period.

In step S36, when the time-out error does not occur (step S36: No), the control device 300 returns to step S31 and repeats each processing.

In step S36, when the time-out error occurs (step S36: Yes), the control device 300 determines whether the normal screen (see FIG. 6) is being displayed on the display of the input/output device 42 (step S37).

In step S37, when the normal screen is not displayed (step S37: No), the control device 300 waits by repeating the processing of step S37 until the normal screen is displayed. The display of the normal screen means that, for example, after the processing of step S17, step S19, or step S23 as described in FIG. 4, the execution-disabled notification screen, the automated parking in-execution screen, or the execution stop notification screen which is transitioned to due to the selection of the automated parking function returns to the normal screen (the selection of the function is cancelled).

In step S37, when the normal screen is displayed (step S37: Yes), the control device 300 turns off the automated parking SW/indicator 39 and notifies that the execution authority of automated parking of the vehicle 30 is disabled (step S38). That is, the control device 300 notifies that the automated parking of the vehicle 30 cannot be performed by turning off the automated parking SW/indicator 39. Further, the control device 300 does not turn off the automated parking SW/indicator 39 until the normal screen is displayed. After turning off the automated parking SW/indicator 39, the control device 300 returns to step S31 and repeats each processing.

On the other hand, in step S34, when the execution authority of the automated parking is not enabled (step S34: No), the control device 300 proceeds to step S37 and performs processing of step S37 and subsequent steps.

Next, the images displayed on the display of the input/output device 42 of the navigation device 40 of the vehicle 30 will be described with reference to FIGS. 6 to 14.

FIG. 6 is a diagram showing an example of images on the normal screen displayed on the display of the input/output device 42. As shown in FIG. 6, in a case where a predetermined function (for example, the automated parking, the automated exit, and the auto lane changing) that is executable by the vehicle 30 is not selected, for example, a top view image 60A and a three-dimensional image 60B of the vehicle 30 are displayed on the display of the input/output device 42 as the image of the normal screen. In this example, the top view image 60A and the three-dimensional image 60B including the external world information around the vehicle 30 are shown as the image of the normal screen, but the present disclosure is not limited thereto, and, for example, a navigation image, a menu image, or an entertainment image may be shown.

FIG. 7 is a diagram showing an example of images displayed when the automated parking SW/indicator 39 for starting the automated parking of the vehicle 30 is pressed. For example, when the automated parking SW/indicator 39 is pressed in a state where the image of the normal screen as shown in FIG. 6 is displayed, an image of a parking position selection screen showing the top view image 60A and the three-dimensional image 60B of the vehicle 30 and parking frames 71, 72, and 73 in which the vehicle 30 can be parked is displayed, as shown in FIG. 7.

In the top view image 60A of the parking position selection screen, a fine adjustment button 61 allowing the three-dimensional image 60B to be displayed in an enlarged manner, and a determination button 62 to be touched after a parking frame indicating a parking position of the vehicle 30 is selected are displayed. Further, in the three-dimensional image 60B of the parking position selection screen, messages such as “please select a parking position” 63 and “please directly confirm the surroundings” 64 are displayed to the user. The parking position selection screen is a screen corresponding to the automated parking pre-execution screen described in step S14 of FIG. 4.

FIG. 8 is a diagram showing an example of an image displayed when a remote parking button for starting the automated parking of the vehicle 30 is pressed. Remote parking refers to automated parking using the RPS, and means that the user uses the information terminal 10 to perform the automated parking of the vehicle 30, for example, from outside the vehicle 30. The remote parking button (not shown) may be, for example, a button provided separately from the automated parking SW/indicator 39.

For example, when the remote parking button is pressed in a state where the image of the normal screen as shown in FIG. 6 is displayed, an image of a preparation screen for the remote parking showing a message such as “please shift to P, get out of the vehicle, and start up the application of the smartphone” 81 is displayed on the display of the input/output device 42, as shown in FIG. 8.

Further, a stop button 82 capable of stopping the remote parking of the vehicle 30 is displayed on the preparation screen of the remote parking. The parking position of the vehicle 30 in the remote parking can be selected by a screen operation on the information terminal 10 when the application is started up, but when the user is in the vehicle 30 and is to select the parking position for the remote parking, the parking position selection screen shown in FIG. 7 may be displayed on the display of the input/output device 42 to allow the user to make a selection. The preparation screen of the remote parking is a screen corresponding to the automated parking pre-execution screen described in step S14 of FIG. 4.

FIG. 9 is a diagram showing an example of an image displayed when the parking frame for automatically parking the vehicle 30 is selected. For example, when any one of the parking frames 71 to 73 for automatically parking the vehicle 30 is selected in a state where the image of the parking position selection screen as shown in FIG. 7 is displayed, an image of an in-execution screen using the APS showing a message such as “the automated parking using the APS is being executed” 83 is displayed on the display of the input/output device 42, as shown in FIG. 9.

A stop button 84 capable of stopping the automated parking of the vehicle 30 is displayed on the in-execution screen. The in-execution screen in the APS is a screen corresponding to the automated parking in-execution screen described in step S19 of FIG. 4.

FIG. 10 is a diagram showing an example of an image displayed when the parking position of the vehicle 30 is selected in the remote parking. For example, when any one of the parking frames 71 to 73 for automatically parking the vehicle 30 is selected in a state where the remote parking button is pressed and the image of the parking position selection screen as shown in FIG. 7 is displayed, an image of an in-execution screen in the RPS showing a message such as “the automated parking using the RPS is being executed” 85 is displayed on the display of the input/output device 42, as shown in FIG. 10.

A stop button 86 capable of stopping the automated parking of the vehicle 30 is displayed on the in-execution screen. The images of the parking position selection screen and the in-execution screen in the RPS may be displayed on the display of the input/output device 42 in the navigation device 40 or on a display screen of the information terminal 10. The in-execution screen in the RPS is a screen corresponding to the automated parking in-execution screen described in step S19 of FIG. 4.

FIG. 11 is a diagram showing an example of an image displayed at a stage where the parking frame is not selected on the parking position selection screen of FIG. 7. For example, when an abnormality occurs in the acquisition of the authority information from the communication unit 38 to the automated driving control unit 100, for example, at a stage where the parking frames 71 to 73 for automatically parking the vehicle 30 are not selected yet although the image of the parking position selection screen as shown in FIG. 7 is displayed, an image of an execution-disabled notification screen in the APS showing a message such as “the automated parking using the APS cannot be executed” 87 is displayed on the display of the input/output device 42, as shown in FIG. 11.

A stop button 88 capable of stopping the automated parking of the vehicle 30 is displayed on the execution-disabled notification screen. The execution-disabled notification screen in the APS is a screen corresponding to the execution-disabled notification screen described in step S17 of FIG. 4.

FIG. 12 is a diagram showing an example of an image displayed at a stage where the parking frame is not selected on the parking position selection screen in the remote parking. For example, when an abnormality occurs in the acquisition of the authority information from the communication unit 38 to the automated driving control unit 100, for example, at a stage where the parking frames 71 to 73 for automatically parking the vehicle 30 are not selected yet although the image of the parking position selection screen as shown in FIG. 7 is displayed in the remote parking, an image of an execution-disabled notification screen in the RPS showing a message such as “the automated parking using the RPS cannot be executed” 89 is displayed on the display of the input/output device 42, as shown in FIG. 12.

A stop button 90 capable of stopping the automated parking of the vehicle 30 is displayed on the execution-disabled notification screen. The image of the execution-disabled notification screen in the RPS may be displayed on the display screen of the information terminal 10. The execution-disabled notification screen in the RPS is a screen corresponding to the execution-disabled notification screen described in step S17 of FIG. 4.

FIG. 13 is a diagram showing an example of an image displayed during execution of the automated parking using the APS described in FIG. 9. For example, when an abnormality occurs in the acquisition of the authority information from the communication unit 38 to the automated driving control unit 100, for example, in a state where the image of the in-execution screen using the APS as shown in FIG. 9 is displayed, that is, during the execution of the automated parking using the APS, an image of an execution stop notification screen in the APS showing a message such as “the automated parking using the APS will be stopped” 91 is displayed on the display of the input/output device 42, as shown in FIG. 13. A stop button 92 capable of stopping the automated parking of the vehicle 30 is displayed on the execution stop notification screen. The execution stop notification screen in the APS is a screen corresponding to the execution stop notification screen described in step S23 of FIG. 4.

FIG. 14 is a diagram showing an example of an image displayed during execution of the automated parking using the RPS described in FIG. 10. For example, when an abnormality occurs in the acquisition of the authority information from the communication unit 38 to the automated driving control unit 100, for example, in a state where the image of the in-execution screen using the RPS as shown in FIG. 10 is displayed in the remote parking, that is, during the execution of the automated parking using the RPS, an image of an execution stop notification screen in the RPS showing a message such as “the automated parking using the RPS will be stopped” 93 is displayed on the display of the input/output device 42, as shown in FIG. 14.

A stop button 94 capable of stopping the automated parking of the vehicle 30 is displayed on the execution stop notification screen. The image of the execution stop notification screen in the RPS may be displayed on the display screen of the information terminal 10. The execution stop notification screen in the RPS is a screen corresponding to the execution stop notification screen described in step S23 of FIG. 4.

As described above, when the execution authority of the automated parking is enabled, the control device 300 turns on the automated parking SW/indicator 39 for notifying that the execution authority is enabled, and when the automated parking function is selected, an execution screen of the automated parking related to execution of the automated parking is displayed on the display of the input/output device 42.

Further, the control device 300 immediately turns off the automated parking SW/indicator 39 when an abnormality occurs in the acquisition of the authority information in a state where the automated parking function is not selected, and turns off the automated parking SW/indicator 39 after returning the displayed execution screen of the automated parking to the normal screen displayed when the automated parking function is not selected, when an abnormality occurs in the acquisition of the authority information in a state where the automated parking function is selected.

According to the configuration, it is possible to prevent a state where a notification content in a selection state of the automated parking function notified by a display image of the input/output device 42 and a notification content of an enabled/disabled state of the execution authority of the automated parking notified by the automated parking SW/indicator 39 are not linked. For example, it is possible to prevent the automated parking SW/indicator 39 from being turned off to notify that the execution authority of the automated parking is disabled although an image of the execution screen of the automated parking is displayed on the display of the input/output device 42. Accordingly, it is possible to easily recognize a plurality of different notification contents in automated parking control of the vehicle 30.

Further, in a case where an abnormality occurs in the acquisition of the authority information when the user does not select the parking frame yet in a state where the automated parking SW/indicator 39 is pressed and the automated parking pre-execution screen is displayed on the display of the input/output device 42, the control device 300 turns off the automated parking SW/indicator 39 after displaying the execution-disabled notification screen for notifying that the automated parking cannot be executed, and in a case where an abnormality occurs in the acquisition of the authority information when the user selects a parking frame on the automated parking pre-execution screen and the automated parking in-execution screen is displayed, the control device 300 turns off the automated parking SW/indicator 39 after displaying the execution stop notification screen for notifying to stop the automated parking and stopping the execution of automated parking.

According to the configuration, it is also possible to prevent the state where the notification content in the selection state of the automated parking function notified by the display image of the input/output device 42 and the notification content of the enabled/disabled state of the execution authority of the automated parking notified by the automated parking SW/indicator 39 are not linked. Further, by displaying the execution-disabled notification screen and the execution stop notification screen, a control state of the automated parking in the vehicle 30 can be accurately and easily notified to the user.

The control method described in the above embodiments may be implemented by executing a control program prepared in advance on a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

Although the embodiments of the present disclosure have been described above, the present disclosure is not limited to the above embodiments, and may be modified, improved, and the like as appropriate.

For example, in the above embodiment, a case where the vehicle 30 performs automated parking (using the APS, the RPS) to a parking space (target parking position) has been described, but the present disclosure is not limited thereto. For example, the control device of the present disclosure may be applied to a case where the vehicle 30 performs automated exit or a case where the vehicle 30 performs auto lane changing (ALC).

In the above embodiment, an example in which the moving object is a vehicle has been described, but the present disclosure is not limited thereto. The idea of the present disclosure is not limited to the vehicle, and may also be applied to a robot, a ship, an aircraft, or the like that includes a drive source and that can be moved by power of the drive source.

In the present specification, at least the following matters are described. Although corresponding constituent elements or the like in the embodiment described above are shown in parentheses, the present invention is not limited thereto.

(1) A control device for a moving object (vehicle 30), including:
an acquisition unit (communication unit 38) configured to acquire authority information related to an execution authority of a predetermined function executable by the moving object; and
a control unit (automated driving control unit 100) configured to execute the predetermined function based on the authority information, in which
in a case where the execution authority is enabled, the control unit
   issues a first notification notifying that the execution authority is enabled,
   stops the first notification in response to an abnormality occurring in acquiring the authority information in a state where a selection of the predetermined function is not made, and
   stops, in response to an abnormality occurring in acquiring the authority information in a state where a selection of the predetermined function is made, the first notification after cancelling the selection of the predetermined function.

According to (1), when an abnormality occurs in the acquisition of the authority information in a state where the predetermined function is selected, the state where the predetermined function is selected is released before the first notification notifying that the execution authority of the predetermined function is enabled is stopped, so that it is possible to prevent a state where a selection state of the predetermined function and a notification content of the first notification are not linked. Therefore, a plurality of different notification contents in movement control of the moving object can be easily recognized.

(2) The control device according to (1), in which
the control unit issues a second notification related to execution of the predetermined function in a state where the selection of the predetermined function is made.

According to (2), by executing the second notification related to execution of the predetermined function, it is possible to easily recognize that the predetermined function is selected.

(3) The control device according to (2), in which
the control unit continues the first notification during a period in which the second notification is being issued.

According to (3), since the first notification is continued without being stopped during the period in which the second notification is being executed, it is possible to prevent the state where a notification content of the second notification and the notification content of the first notification are not linked.

(4) The control device according to any one of (1) to (3), in which
in a case where the execution authority is enabled and the selection of the predetermined function is made, the control unit
   stops, in response to an abnormality occurring in acquiring the authority information before execution of the predetermined function, the first notification after issuing a third notification indicating that the predetermined function is not executable, and
   stops, in response to an abnormality occurring in acquiring the authority information during the execution of the predetermined function, the first notification after issuing a fourth notification indicating the execution of the predetermined function is stopped and stopping the execution of the predetermined function.

According to (4), when an abnormality occurs in the acquisition of the authority information in a state where the predetermined function is selected, before the execution of the predetermined function, the third notification notifying that the execution of the predetermined function is not executable is issued before the first notification is stopped, and during the execution of the predetermined function, the fourth notification notifying to stop the execution of the predetermined function is issued before the first notification is stopped, and thus it is possible to prevent the state where the selection state of the predetermined function and the notification content of the first notification are not linked. Further, by displaying the third notification and the fourth notification, a control state of the automated parking can be accurately and easily notified to the user.

(5) The control device according to any one of (1) to (4), in which
the control unit is capable of performing
   a first screen display in a state where the predetermined function is selected, and
   a second screen display in a state where the predetermined function is not selected, and
when a selection of the predetermined function is made and the first screen display is performed, the control unit stops the first notification after transitioning the first screen display to the second screen display in response to an abnormality occurring in acquiring the authority information.

According to (5), when an abnormality occurs in the acquisition of the authority information in a state where the predetermined function is selected, the first screen display in a state where the predetermined function is selected is transitioned to the second screen display in a state where the predetermined function is not selected before the first notification is stopped, and thus it is possible to prevent the state where the selection state of the predetermined function and the notification content of the first notification are not linked.

(6) The control device according to (5), in which
the predetermined function includes a function related to movement of the moving object, and
the first screen display includes a display of an execution screen of the function related to the movement.

According to (6), by displaying the execution screen of the function related to the movement of the moving object as the first screen display in a state where the predetermined function is selected, it is possible to easily recognize that the predetermined function is selected.

(7) The control device according to (5) or (6), further including:
an external world information acquisition unit (camera 31 or the likes) configured to acquire external world information around the moving object, in which
the second screen display includes a display of the external world information.

As in (7), it is desirable that a content of the second screen display in a state where the predetermined function is not selected is the external world information around the moving object.

(8) The control device according to any one of (1) to (7), in which
the acquisition unit is a communication unit that acquires the authority information through communication with a server.

As in (8), it is desirable to use the communication unit that communicates with the server in order to acquire the authority information related to the execution authority of the predetermined function.

(9) The control device according to (8), in which
the communication unit receives contract information of a user of the moving object from the server as the authority information.

As in (9), it is preferable that the authority information related to the execution authority of the predetermined function includes the contract information of the user of the moving object.

(10) The control device according to (8) or (9), in which
the control unit determines whether an abnormality occurs in acquiring the authority information based on an abnormality in communication between the communication unit and the control unit.

As in (10), it is preferable to determine the presence or absence of an abnormality in the communication between the communication unit and the control unit in order to detect an abnormality occurring during the acquisition of the authority information.

(11) The control device according to any one of (1) to (10), in which
the control unit determines whether an abnormality occurs in the communication between the communication unit and the control unit based on a period in which there is no response from the communication unit.

As in (11), when it is to determine whether an abnormality occurs in the communication between the communication unit and the control unit, it is preferable to detect a period in which there is no response from the communication unit.

(12) A control method to be performed by a control device for a moving object, the control device including an acquisition unit configured to acquire authority information related to an execution authority of a predetermined function executable by the moving object, and a processor configured to execute the predetermined function based on the authority information, the control method including:
in a case where the execution authority is enabled,
   issuing, by the processor, a first notification notifying that the execution authority is enabled;
   stopping, by the processor, the first notification in response to an abnormality occurring in acquiring the authority information in a state where a selection of the predetermined function is not made; and
   stopping, by the processor, in response to an abnormality occurring in acquiring the authority information in a state where a selection of the predetermined function is made, the first notification after cancelling the selection of the predetermined function.

According to (12), when an abnormality occurs in the acquisition of the authority information in a state where the predetermined function is selected, the state where the predetermined function is selected is released before the first notification notifying that the execution authority of the predetermined function is enabled is stopped, so that it is possible to prevent the state where the selection state of the predetermined function and the notification content of the first notification are not linked. Therefore, a plurality of different notification contents in the movement control of the moving object can be easily recognized.

(13) A non-transitory computer-readable storage medium storing a control program of a control device for a moving object, the control device including an acquisition unit configured to acquire authority information related to an execution authority of a predetermined function executable by the moving object, and a processor configured to execute the predetermined function based on the authority information, the control program causing the processor to:
in a case where the execution authority is enabled,
   issue a first notification notifying that the execution authority is enabled;
   stop the first notification in response to an abnormality occurring in acquiring the authority information in a state where a selection of the predetermined function is not made; and
   stop, in response to an abnormality occurring in acquiring the authority information in a state where a selection of the predetermined function is made, the first notification after cancelling the selection of the predetermined function.

According to (13), when an abnormality occurs in the acquisition of the authority information in a state where the predetermined function is selected, the state where the predetermined function is selected is released before the first notification notifying that the execution authority of the predetermined function is enabled is stopped, so that it is possible to prevent the state where the selection state of the predetermined function and the notification content of the first notification are not linked. Therefore, a plurality of different notification contents in the movement control of the moving object can be easily recognized.

What is claimed is:

1. A control device for a moving object, comprising:
an acquisition unit configured to acquire authority information related to an execution authority of a predetermined function executable by the moving object; and
a control unit configured to execute the predetermined function based on the authority information, wherein
in a case where the execution authority is enabled, the control unit
issues a first notification notifying that the execution authority is enabled,
stops the first notification in response to an abnormality occurring in acquiring the authority information in a state where a selection of the predetermined function is not made, and
stops, in response to an abnormality occurring in acquiring the authority information in a state where a selection of the predetermined function is made, the first notification after cancelling the selection of the predetermined function.

2. The control device according to claim 1, wherein
the control unit issues a second notification related to execution of the predetermined function in a state where the selection of the predetermined function is made.

3. The control device according to claim 2, wherein
the control unit continues the first notification during a period in which the second notification is being issued.

4. The control device according to claim 1, wherein
in a case where the execution authority is enabled and the selection of the predetermined function is made, the control unit
stops, in response to an abnormality occurring in acquiring the authority information before execution of the predetermined function, the first notification after issuing a third notification indicating that the predetermined function is not executable, and
stops, in response to an abnormality occurring in acquiring the authority information during the execution of the predetermined function, the first notification after issuing a fourth notification indicating the execution of the predetermined function is stopped and stopping the execution of the predetermined function.

5. The control device according to claim 1, wherein
the control unit is capable of performing
a first screen display in a state where the predetermined function is selected, and
a second screen display in a state where the predetermined function is not selected, and
when a selection of the predetermined function is made and the first screen display is performed, the control unit stops the first notification after transitioning the first screen display to the second screen display in response to an abnormality occurring in acquiring the authority information.

6. The control device according to claim 5, wherein
the predetermined function includes a function related to movement of the moving object, and
the first screen display includes a display of an execution screen of the function related to the movement.

7. The control device according to claim 5, further comprising:
an external world information acquisition unit configured to acquire external world information around the moving object, wherein
the second screen display includes a display of the external world information.

8. The control device according to claim 1, wherein
the acquisition unit is a communication unit that acquires the authority information through communication with a server.

9. The control device according to claim 8, wherein
the communication unit receives contract information of a user of the moving object from the server as the authority information.

10. The control device according to claim 8, wherein
the control unit determines whether an abnormality occurs in acquiring the authority information based on an abnormality in communication between the communication unit and the control unit.

11. The control device according to claim 8, wherein
the control unit determines whether an abnormality occurs in the communication between the communication unit and the control unit based on a period in which there is no response from the communication unit.

12. A control method to be performed by a control device for a moving object, the control device including an acquisition unit configured to acquire authority information related to an execution authority of a predetermined function executable by the moving object, and a processor configured to execute the predetermined function based on the authority information, the control method comprising:
in a case where the execution authority is enabled,
issuing, by the processor, a first notification notifying that the execution authority is enabled;
stopping, by the processor, the first notification in response to an abnormality occurring in acquiring the authority information in a state where a selection of the predetermined function is not made; and
stopping, by the processor, in response to an abnormality occurring in acquiring the authority information in a state where a selection of the predetermined function is made, the first notification after cancelling the selection of the predetermined function.

13. A non-transitory computer-readable storage medium storing a control program of a control device for a moving object, the control device including an acquisition unit configured to acquire authority information related to an execution authority of a predetermined function executable by the moving object, and a processor configured to execute the predetermined function based on the authority information, the control program causing the processor to:
in a case where the execution authority is enabled,
issue a first notification notifying that the execution authority is enabled;
stop the first notification in response to an abnormality occurring in acquiring the authority information in a state where a selection of the predetermined function is not made; and
stop, in response to an abnormality occurring in acquiring the authority information in a state where a selection of the predetermined function is made, the first notification after cancelling the selection of the predetermined function.
